(19) United States
(12) Patent Application Publication
(10) Pub. No.: US 2022/0404814 A1
(43) Pub. Date: Dec. 22, 2022

(54) Remote Activation of the Wireless Service Interface of a Control Device Via a Radio Interface

(71) Applicant: Siemens Schweiz AG, Zürich (CH)

(72) Inventors: Beat Kyburz, Ottenbach (CH); Herbert Meier, Baar (CH)

(73) Assignee: Siemens Schweiz AG, Zürich (CH)

(21) Appl. No.: 17/777,413

(22) PCT Filed: Nov. 18, 2020
(86) PCT No.: PCT/EP2020/082573

§ 371 Date: May 17, 2022

(30) Foreign Application Priority Data
Nov. 19, 2019 (DE) 10 2019 217 771.9

(51) Int. Cl. G05B 19/418; G05B 15/02

(52) U.S. Cl. CPC G05B 19/41855; G05B 15/02; G05B 2219/25167

(57) ABSTRACT

Various embodiments of the teachings herein include a control device comprising: a wireless service interface; and a controller. The control device receives a radio signal generated by a device via a suitable radio connection using a further wireless interface and activates the wireless service interface once receiving the radio signal.

### CROSS-REFERENCE TO RELATED APPLICATIONS

This application is a U.S. National Stage Application of International Application No. PCT/EP2020/082573 filed Nov. 18, 2020, which designates the United States of America, and claims priority to DE Application No. 10 2019 217 771.9 filed Nov. 19, 2019, the contents of which are hereby incorporated by reference in their entirety.

### TECHNICAL FIELD

The present disclosure relates to building automation. Various embodiments of the teachings herein include control devices for controlling one or more field devices connected to the control device in a data-transmitting manner via a communications network and/or methods for transmitting data to a control device for controlling one or more field devices connected to the control device in a data-transmitting manner via a communications network.

### BACKGROUND

The commissioning of building automation systems for heating, ventilation, air conditioning, etc. requires the efficient loading of larger volumes of data (e.g. application software, parameterization data, text libraries, UI graphics for the user interface) to the control devices (e.g. controllers, automation devices) required for this purpose. Often a firmware update (for bug fixes, security updates or functional extensions) is also required during commissioning or maintenance of the control devices. When control devices (e.g. IP-based controllers) for building automation which communicate via an Internet Protocol (e.g. IPv4, IPv6) are commissioned, the IP building network (backbone) is often not ready for operation yet and the efficient loading of larger volumes of data via the backbone is therefore not possible.

The loading of larger volumes of data to control devices with a “non-IP building network” (e.g. BACnet MSTP Backbone) is generally very inefficient due to the low transmission capacity and would take far too long for commissioning (e.g. hours for a firmware update). In principle, larger volumes of data could be efficiently loaded onto the controller (control device) via a local USB interface on the controller. However, the controllers for automation systems are often installed in poorly accessible locations (e.g. in the false ceiling, in window panels or in the false floor) and attaching a USB cable between the tool and controller is difficult and time-consuming. In addition, USB cables are limited to a few meters in length.

### SUMMARY

The teachings of the present disclosure provide a control device onto which larger volumes of data can be loaded efficiently and/or methods for efficiently loading larger volumes of data onto a control device, in particular for building automation. For example, some embodiments include a control device (SG), in particular for building automation, wherein the control device (SG) comprises a wireless service interface (SS), characterized in that the control device (SG) is designed to receive a radio signal (FSIG) generated by a device (G1, G2) via a suitable radio connection (KV2, KV3) by means of a further wireless interface (FS1, FS2) and to activate the wireless service interface (SS) on the basis of the radio signal (FSIG).

In some embodiments, the control device (SG) is designed to simulate the activation of a service button (ST) located locally on the control device (SG) by the received radio signal (FSIG) and thereby to activate the wireless service interface (SS).

In some embodiments, after activation of the wireless service interface (SS), the control device (SG) is designed to receive data (FW) and/or transmit data by means of the wireless service interface (SS).

In some embodiments, the control device (SG) is designed to automatically deactivate the wireless service interface (SS) after receiving or transmitting the data (FW).

In some embodiments, the device is a mobile communication terminal (G1).

In some embodiments, the device is a wireless communication field device (G2).

In some embodiments, the control device (SG) is designed to receive a radio signal (FSIG′) generated by a device (G1, G2, mobile communication terminal or wireless field device) via a suitable radio connection (KV2, KV3) and to deactivate the wireless service interface (SS) on the basis of the radio signal (FSIG′).

As another example, some embodiments include a method for transmitting data to a control device (SG), in particular for building automation, (VS1) wherein a wireless service interface (SS) of the control device (SG) is activated via a radio signal (FSIG) generated by a device (G1, G2) and sent to the control device (SG), wherein the radio signal (FSIG) is received by a further wireless interface (FS1, FS2) of the control device (SG); (VS2) wherein after the activation of the wireless service interface by a tool (T), data is transferred via the wireless service interface (SS) to the control device (SG), or data is transferred from the control device (SG) to the tool (T).

In some embodiments, activation of a service button (ST) located locally on the control device (SG) is simulated by the radio signal (FSIG) received from the control device (SG) and the wireless service interface (SS) of the control device (SG) is activated thereby.

In some embodiments, after the data (FW) has been transferred, the wireless service interface (SS) is automatically deactivated.

In some embodiments, via a further radio signal (FSIG′) generated by a device (G1, G2) and sent to the control device (SG), the wireless service interface (SS) of the control device (SG) is deactivated.

In some embodiments, the device is a mobile communication terminal (G1) or a correspondingly designed field device (G2).

### BRIEF DESCRIPTION OF THE DRAWINGS

The teachings and advantageous embodiments of the present disclosure are described using the example of the figures hereinafter. The figures show:

FIG. 1 An exemplary communications network with an exemplary control device incorporating teachings of the present disclosure and field devices; and

FIG. 2 An exemplary flow chart for a method for transmitting data to a control device incorporating teachings of the present disclosure.

### DETAILED DESCRIPTION

The teachings herein include a control device (e.g. controller, automation device), wherein the control device comprises a wireless service interface (wireless service interface, e.g. Wi-Fi interface, WLAN), wherein the control device is designed to receive a radio signal (FSIG) generated by a device (e.g. mobile communication terminal, smartphone, or wireless communication field device) via a suitable radio connection (e.g. Thread, ZigBee, Bluetooth, NFC) by means of a further wireless interface and to activate the wireless service interface (e.g. WLAN) on the basis of the radio signal. The control device can be advantageously used or designed in particular for building automation, for controlling one or more field devices (e.g. actuators, sensors) which are connected to the control device in a data-transmitting manner by a communications network, in particular by a field bus (e.g. KNX bus). The radio signal transmitted from the device (e.g. smartphone, tablet computer, or wireless communication field device) to the control device to activate the service interface can, for example, take place via NFC (Near Field Communication), via Bluetooth, via Thread, or via ZigBee protocols.

By means of this simple and clear remote activation of the local wireless service interface, e.g. a service technician or facility manager can very quickly and efficiently start the rapid downloading of the required data to the corresponding controller. The building backbone (i.e. the backbone network in the building, e.g. an IP network) does not have to be operational for this. A time-consuming localization of the controller in poorly accessible locations and the removal of false ceilings, window panels or false floors to attach a USB cable to the controller or to activate the service button on the controller (control device) are no longer necessary. Service calls during operation are significantly simplified and accelerated because the data can be loaded onto the controller (control device) at high speed via the wireless service interface. Commissioning of the controller and service work (e.g. maintenance, installation of patches, firmware updates) are significantly faster and more reliable.

In some embodiments, the control device is designed to simulate the activation of a service button located locally on the control device (SG) by means of the received radio signal and thereby to activate the wireless service interface. When the control device receives a corresponding radio signal from a device to a corresponding radio interface (e.g. radio interface for NFC, Bluetooth, Thread, or ZigBee protocols) of the control device, the activation of a service button located locally on the control device is simulated by the logic stored in the control device (advantageously by corresponding software) and the wireless service interface (e.g. WLAN interface) of the control device (controller) activated thereby. The controller, i.e. the control device, converts this received signal by simulating the activation of the local service button on the control device, as if someone had activated the service button locally on the controller. After receipt of the corresponding radio signal, the wireless service interface of the control device is activated.

In some embodiments, after activating the wireless service interface, the control device is designed to receive data (e.g. firmware, firmware update) and/or to transmit data via the wireless service interface data (e.g. configurations, service protocols). Commissioning and service calls during operation are significantly simplified and accelerated because the data can be loaded onto the control device at high speed via the wireless service interface. The data can be transferred by a correspondingly designed tool to the control device or received by the control device. The tool (computer-assisted tool) can be, for example, a mobile communication terminal, smartphone, tablet computer, or personal computer (PC) which is equipped, for example, with corresponding software for an engineering tool and/or commissioning tool and/or configuration tool. Tools and devices can be operated by various operators or by the same operator. Devices and tools can be physically different appliances. However, devices and tools can also be identical.

In some embodiments, the control device is designed to automatically deactivate the wireless service interface after receiving or transmitting data. By automatically deactivating the wireless service interface by means of timeout, manual deactivation by the service technician (which is often forgotten) after the service work has been completed is no longer necessary.

In some embodiments, the wireless service interface is automatically deactivated after a defined period of time if not used. By automatically deactivating the wireless service interface by means of timeout, manual deactivation by the service technician (which is often forgotten) after the service work has been completed is no longer necessary.

In some embodiments, the device is a correspondingly designed mobile communication terminal, e.g. a smartphone, tablet computer, or PDA. These devices are customary devices with which service technicians or commissioning technicians are customarily equipped. These devices customarily comprise the required hardware and software components or can be equipped therewith.

In some embodiments, the device is a wireless communication field device (e.g. room device). The wireless field device can, for example, communicate with the control device using standard Thread or ZigBee protocols via a corresponding radio interface. This radio interface is not the wireless service interface (e.g. WLAN interface) of the control device. Advantageously, the device, i.e. the wireless field device, is integrated into the communications network for the field devices to be controlled by the control device.

In some embodiments, the control device is designed to receive a radio signal generated by a device via a suitable radio connection and to deactivate the wireless service interface on the basis of the radio signal. This can take place conveniently by means of a corresponding operator input.

In some embodiments, there is a method for transmitting data to a control device (e.g. controller, automation device), in particular for building automation, wherein a radio signal generated by a device (e.g. mobile communication terminal (e.g. smartphone, tablet computer) or wireless communication field device) and sent to the control device is activated, wherein the radio signal is received by a further wireless interface (e.g. via a radio interface for NFC, Bluetooth, Thread, or ZigBee protocols) of the control device (SG); and wherein after the activation of the wireless service interface by a tool (e.g. commissioning tool, engineering tool, tablet computer, PC), data is transferred via the wireless service interface (e.g. WLAN) to the control device, or data is transferred from the control device to the tool. The radio signal sent from the device (e.g. smartphone, tablet computer, or wireless communication field device) to the control device to activate the service interface can, for example, be sent via NFC (Near Field Communication), via Bluetooth, via Thread, or via ZigBee protocols. The method is advantageously used for a control device (e.g. controller, automation device), for controlling one or more field devices which are connected to the control device in a data-transmitting manner by a communications network, in particular by a field bus (e.g. KNX bus). Large volumes of data can thus be rapidly loaded onto the control device in the field.

In some embodiments, activation of a service button located locally on the control device is simulated by the radio signal received from the control device and the wireless service interface of the control device is activated thereby. The control device (e.g. controller, PLC, SPS) is designed to convert this received service signal such that the activation of the local service button is simulated on the controller, as if someone had activated the service button locally on the controller.

In some embodiments, after the data has been transferred, the wireless service interface is automatically deactivated. By automatically deactivating the wireless service interface by means of timeout, manual deactivation by the service technician (which is often forgotten) after the service work has been completed is no longer necessary.

In some embodiments, the wireless service interface is automatically deactivated after a defined period of time if not used. By automatically deactivating the wireless service interface by means of timeout, manual deactivation by the service technician (which is often forgotten) after the service work has been completed is no longer necessary.

In some embodiments, the wireless service interface of the control device is deactivated via a radio signal generated by a device and sent to the control device. The Wi-Fi interface of the control device (e.g. controller) can thus not only be switched on by a device (e.g. smartphone), but also manually switched off via another command, e.g. by means of an explicit command from a service technician.

In some embodiments, the device is a mobile communication terminal (e.g. smartphone, tablet computer) or a correspondingly designed field device. Mobile communication terminals are part of the standard equipment of a service technician.

In some embodiments, there is an arrangement for implementation of the methods described herein. The methods can be implemented or updated using customary components (COTS, Commercials off the Shelf).

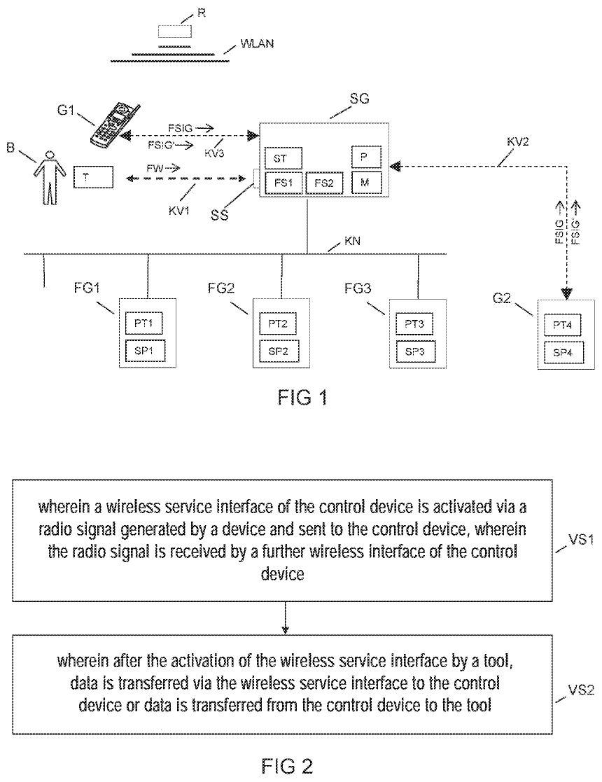

FIG. 1 shows an exemplary communications network KN with an exemplary control device SG incorporating teachings of the present disclosure. The control device SG is designed to control exemplary field devices FG1-FG3. The exemplary control device SG can be, for example, a correspondingly designed controller or an automation device for building automation, for example for the control or regulation of HVAC functionality (heating, ventilation, air conditioning) in a building. In some embodiments, the communications network KN is a field bus or an installation bus (e.g. KNX bus system). The field devices FG1-FG3 are, for example, actuators (e.g. drives for awnings or blinds, dimmers, temperature displays, alarm indicators, etc.) or sensors (e.g. temperature sensors, temperature probes, motion detectors, presence detectors, dim buttons, etc.).

The exemplary control device SG according to FIG. 1 is designed to control one or more field devices FG1-FG3, the field devices FG1-FG3 being connected in a data-transmitting manner to the control device SG via a communications network KN (e.g. field bus or installation bus). The control device SG comprises a wireless service interface SS (e.g. WLAN, Wi-Fi interface), the control device SG being designed to receive a radio signal FSIG generated by a device G1, G2 and to activate the wireless service interface SS on the basis of the radio signal FSIG. In the illustration of FIG. 1, the exemplary device G1 is a mobile communication terminal (e.g. smartphone, tablet computer) and the exemplary device G2 is a field device which is designed for wireless communication. The exemplary device G1 communicates via a suitable radio connection KV3 with the control device SG. The exemplary device G2 communicates via a suitable radio connection KV2 with the control device SG. The radio connections KV2, KV3 can be an NFC, Bluetooth, Thread, or ZigBee connection. In addition to the service interface SS (e.g. WLAN), the control device SG comprises one or more radio interfaces FS1, FS2 for wireless communication with the devices G1, G2.

Each of the field devices FG1-FG3, G2 customarily comprises a corresponding programming button PT1-PT4 and/or a corresponding service pin SP1-SP4.

The control device SG is designed to receive and correspondingly assess a radio signal FSIG. The control device SG comprises a processor P for executing program instructions (in particular software (e.g. applications) or firmware FW). Furthermore, the control device SG comprises one or more storage media M (e.g. main memory or flash memory) for acceptance of application software, firmware FW or an operating system.

Nowadays, controller or control devices SG are increasingly equipped with a local wireless service interface SS (e.g. Wi-Fi, Bluetooth). The wireless service interface SS must be manually activated by the technician for service purposes and switches itself off again automatically after a timeout, so that the wireless service interface SS is permanently deactivated during normal operation (e.g. due to building IT administration specifications; as an IT security protective measure; or because of lower power consumption as a result of the radio module in the controller SG being switched off during normal operation).

Hitherto, the wireless service interface SS was activated via a local service button ST on the control device SG (controller). Due to poorly accessible mounting locations of the control device SG, the activation of this service button ST for activation of the wireless service interface SS by an operator B is in turn difficult and time-consuming (e.g. dismantling of the panel, opening of the ceiling). The control device SG is therefore designed to simulate the activation of a service button ST located locally on the control device SG by means of the received service signal SIG and thereby to activate the wireless service interface SS. The wireless service interface SS is, for example, a radio interface (e.g. Wi-Fi interface).

The control device SG is equipped with one or more radio interfaces FS1, FS2 to receive a radio signal FSIG via NFC, Bluetooth, Thread, or ZigBee connections KV2, KV3.

After activation of the wireless service interface SS, the control device SG is designed to receive data (e.g. firmware FW and/or application programs) and/or to send data via the wireless service interface SS. In the illustration according to FIG. 1, after activation of the wireless service interface SS, the control device SG is located in the WLAN network of an exemplary router R. After activation of the wireless service interface SS, an operator B (e.g. commissioning engineer or service technician) can load firmware FW or a firmware update onto the control device SG via a tool T (e.g. mobile communication terminal, smartphone, tablet computer, PC). The communication connection KV between the tool T (e.g. engineering tool or commissioning tool) and the control device SG is established by means of the WLAN network of the router S.

In some embodiments, a control device SG, in particular for building automation, for controlling one or more field devices FG1-FG3, which are connected to the control device SG in a data-transmitting manner via a communications network KN, in particular via a field bus, comprises a wireless service interface SS, wherein the control device SG is designed to receive a radio signal FSIG generated by a device G1, G2 via a suitable radio connection KV2, KV3 via a further wireless interface FS1, FS2 and to activate the wireless service interface SS based on the radio signal FSIG. The control device SG simulates the activation of a service button ST located locally on the control device SG by means of the received radio signal FSIG and thereby to activate the wireless service interface SS.

After activation of the wireless service interface SS, the control device SG is designed to receive data FW (e.g. firmware or operating system updates) and/or to send data via the wireless service interface SS. The control device SG is designed to automatically deactivate the wireless service interface SS after receiving or sending the data FW. In some embodiments, the device G1, G2 is a mobile communication terminal (G1) or a wireless communication field device (G2).

In some embodiments, the control device SG is designed to receive a radio signal FSIG′ generated by a device G1, G2 (e.g. mobile communication terminal or wireless field device) via a suitable radio connection KV2, KV3 and to deactivate the wireless service interface SS (e.g. WLAN interface) based on the radio signal FSIG′. The device can be a mobile communication terminal G1 (e.g. smartphone, tablet computer) or a correspondingly designed field device G2. The respective radio connection KV2, KV3 is restricted to the near field around the mobile communication terminal G1 or the field device G2. The radio connection KV2, KV3 between the mobile communication terminal G1 or the field device G2 and the control device SG can, for example, be established according to the Bluetooth standard, the Thread standard, the Zigbee standard or according to NFC (Near Field Communication). The radio connection between the mobile communication terminal or the field device and the control device is established by means of corresponding chipsets and antennae in the respective devices G1, G2 or control devices SG.

FIG. 2 shows an exemplary flow chart for a method for transferring data (e.g. firmware, firmware update) to a control device (e.g. controller), in particular for building automation, (VS1) wherein a wireless service interface (e.g. WLAN) of the control device is activated via a radio signal FSIG generated by a device (e.g. mobile communication terminal, wireless field device) and sent to the control device, wherein the radio signal FSIG is received by a further wireless interface (e.g. NFC, Bluetooth, Zigbee, Thread (a network protocol based on IPv6) of the control device; (VS2) wherein after the activation of the wireless service interface by a tool T (e.g. engineering tool or commissioning tool), data is transferred via the wireless service interface to the control device or data is transferred from the control device to the tool. The tool can be implemented, for example, on a mobile communication terminal, smartphone, tablet computer, PC.

The radio signal received by the control device (e.g. controller) simulates the activation of a service button located locally on the control device and thereby activates the wireless service interface (e.g. WLAN interface) of the control device. In some embodiments, the wireless service interface is automatically deactivated after the data (e.g. firmware) has been transferred. In some embodiments, the wireless service interface is automatically deactivated after a defined period of time (timeout) if not used.

A further radio signal (FSIG′) generated by a device (e.g. mobile communication terminal, smartphone) and sent to the control device advantageously deactivates the wireless service interface of the control device. The device can be a mobile communication terminal (e.g. smartphone, tablet computer) or a correspondingly designed field device. In some embodiments, the radio connection is restricted to the near field around the mobile communication terminal or the field device. The radio connection between the mobile communication terminal or the field device and the control device can, for example, be established according to the Bluetooth standard, the Thread standard, the Zigbee standard or according to NFC (Near Field Communication). The radio connection between the mobile communication terminal or the field device and the control device is established by means of corresponding chipsets and antennae in the respective devices or control devices.

In some embodiments, an arrangement implements a method incorporating teachings of the present disclosure. The method and an arrangement to implement the method can be implemented with the infrastructure (e.g. WLAN router) that is customarily already present in a building.

Exemplary scenario for the use of the method:
a. A tool_A (tablet, mobile phone) serves to activate the Wi-Fi service interface on the controller via an alternative, less performant radio interface such as, for example, Bluetooth or NFC.
b. A tool_B serves to load large volumes of data onto the controller via the performant Wi-Fi service interface
c. Tool_A and tool_B can be identical.
d. The Wi-Fi service interface is activated by a tool_A via Bluetooth or NFC.
   i. The pairing and the structure of an ad hoc connection between the tool_A and the controller via Bluetooth or NFC is possible with great ease.
   ii. The pairing mechanisms for Bluetooth or NFC are well known.
   iii. By means of a mobile app, the tool_A sends a command to the controller via Bluetooth or NFC for the remote activation of the local Wi-Fi service interface
   iv. Or the explicit manual activation and deactivation of the local Wi-Fi service interface can take place by means of corresponding tool commands from tool_A via specific commands via Bluetooth or NFC.
   v. The selected controller can be easily identified on a tool_B by detecting the wireless network (e.g. of a new Wi-Fi SSID) and connected to the tool_B.
   vi. Alternatively, the tool_A can reconnect with the controller via the activated Wi-Fi service interface, for example, by switching the connection from Bluetooth or NFC to Wi-Fi.
      Switching the connection from Bluetooth or NFC to Wi-Fi can take place on a largely automated basis on the tablet or mobile phone.
e. As an alternative to the solution via tablet or mobile phone described in a) . . . d), the Wi-Fi service interface can be activated by a wireless field device (e.g. room device) via an alternative wireless protocol such as Thread or ZigBee.
   i. The wireless field device must be connected to the controller for this purpose
   ii. The manual activation and deactivation of the local Wi-Fi service interface takes place by means of corresponding commands from the field device via Thread or ZigBee.
f. After connecting tool_B (or tool_A) to the Wi-Fi service interface, larger volumes of data can be loaded onto the controller (control device) very easily and quickly.
g. The activated Wi-Fi service interface switches off automatically when not in use (after a timeout).
h. After a controller reboot, the Wi-Fi service interface is no longer switched on (e.g. reboot after successful FW (firmware) download).

Exemplary Advantages of the Present Disclosure:
On mobile devices such as tablets or mobile phones, which are increasingly used as commissioning tools, besides Wi-Fi, there are also further wireless interfaces such as Bluetooth and NFC.
Due to the widespread use of Bluetooth and NFC in the field of consumer electronics, in addition to a Wi-Fi interface, these radio interfaces can be installed highly cost-effectively in controllers.
In addition to conventional wired field bus systems, wireless protocols such as Thread are increasingly being used for the integration of IoT peripheral devices.
Commercially available radio chips support Bluetooth and Thread in combination, so that both wireless protocols are available at low cost.
The invention the increasing spread of wireless protocols such as Bluetooth, NFC, Thread, ZigBee in the Building Automation domain.
In addition, optimum use is made of the standard interfaces available on mobile devices such as Wi-Fi, Bluetooth, NFC.
By simply and clearly activating the local Wi-Fi service interface remotely, the service technician can very quickly, efficiently and securely identify (locate) the correct controller for the room and immediately start the rapid downloading of the required data. The building backbone does not necessarily have to be operational for this purpose.
The time-consuming localization of the controller in poorly accessible locations and the removal of false ceilings, window panels or false floors to activate the service button is no longer necessary.
Service deployments during operation are significantly simplified and accelerated because the data can be loaded at high speed via the Wi-Fi service interface.
Due to the automatic deactivation of the Wi-Fi service interface by means of timeout, manual deactivation by the service technician (which is often forgotten) after completion of the service work is no longer necessary
The implementation of commissioning and service work is significantly faster and more reliable.

A method for transferring data to a control device (e.g. controller, automation device), in particular for building automation, for controlling one or more field devices which are connected to the control device in a data-transmitting manner via a communications network (e.g. field bus), wherein via a radio signal (FSIG) generated by a device (e.g. mobile communication terminal or wireless communication field device) and transmitted to the control device, a wireless service interface (for example, Wi-Fi interface, WLAN) of the control device is activated, and wherein after the activation of the wireless service interface by a tool (e.g. engineering tool; PC, tablet computer), data is transferred via the wireless service interface to the control device or data is transferred from the control device to the tool. The radio signal transmitted from the device (e.g. smartphone, tablet computer) to the control device to activate the service interface can, for example, take place via NFC (Near Field Communication), via Bluetooth, via Thread, or via ZigBee protocols.

### REFERENCE CHARACTERS

SG Control device
ST Service button
SS Service interface
P Processor
M Memory
FS1,FS2 Radio interface
R Router
WLA Wireless network
KV1-KV3 Communication connection
KN Communications network
FG1-FG3 Field device
PT1-PT4 Programming button
SP1-SP4 Service pin
FSIG, FSIG′ Radio signal
T Tool
B User
FW Firmware
G1, G2 Device
VS1 VS2 Step

What is claimed is:

1. A control device comprising:
a wireless service interface; and
a controller;
wherein the control device receives a radio signal generated by a second device via a radio connection using a further wireless interface and activates the wireless service interface upon receiving the radio signal.

2. The control device as claimed in claim 1, wherein the control device simulates the activation of a service button located on the control device upon receiving the radio signal and thereby activates the wireless service interface.

3. The control device as claimed claim 1, wherein after activation of the wireless service interface, the control device receives data or transmits data using the wireless service interface.

4. The control device as claimed in claim 3, wherein the control device automatically deactivates the wireless service interface after receiving or transmitting the data.

5. The control device as claimed in claim 1, wherein the second device comprises a mobile communication terminal.

6. The control device as claimed in claim 1, wherein the second device comprises a wireless communication field device.

7. The control device as claimed in claim 1, wherein the control device receives the radio signal generated by the second device via a radio connection and deactivates the wireless service interface on the basis of the radio signal.

8. A method for transmitting data to a control device, the method comprising:
activating a first wireless service interface of the control device via a radio signal generated by a second device and sent to the control device, wherein the radio signal is received by a second wireless interface of the control device;
after activation of the wireless service interface, transferring data via the first wireless service interface to the control device, or transferring data from the control device to a tool.

9. The method as claimed in claim 8, wherein activation of the first wireless service interface includes simulating pressing a service button located on the control device by the radio signal received from the second device.

10. The method as claimed in claim 8, further comprising automatically deactivating the first wireless service interface after the data has been transferred.

11. The method as claimed in claim 8, further comprising deactivating the first wireless service interface upon receipt of a further radio signal generated by the second device and sent to the control device.

12. The method as claimed in claim 9, wherein the second device comprises a mobile communication terminal or a correspondingly designed field device.

13. (canceled)
